(19) United States
(12) Patent Application Publication
(10) Pub. No.: US 2007/0214605 A1
(43) Pub. Date: Sep. 20, 2007

(54) Sleeve joint type hinge

(75) Inventor: Chung-Ho Tu, Sinjhuang City (TW)

Correspondence Address: John G. Chupa;Law Offices of John Chupa & Associates, P.C., Suite 50, 28535 Orchard Lake Road, Farmington Hills, MI, 48334, US

(73) Assignee: JARLLYTEC CO., LTD.

(21) Appl. No.: 11/545,376

(22) Filed: Oct. 10, 2006

(30) Foreign Application Priority Data
Mar. 16, 2006 (TW) 095204316

(51) Int. Cl. E05D 11/08

(52) U.S. Cl. 16/342

(57) ABSTRACT

A sleeve joint type hinge includes a barrel, a pivot shaft, inserted into and rotatable relative to the barrel, and an arched resilient friction member, which has two hooked portions respectively extending from the two distal ends thereof and hooked on the periphery of the pivot shaft and a middle protruding portion kept spaced from a tangential peripheral plane of the pivot shaft and disposed in close contact with the inside wall of the barrel to produce a friction resistance and to hold the pivot shaft positively in positive after each rotary motion of the pivot shaft relative to the barrel by an external biasing force.

### BACKGROUND OF THE INVENTION

1. Field of the Invention

The present invention relates to hinges and more particularly, to a sleeve joint type hinge, which has at least one friction member provided between a first hinge member (the barrel) and a second hinge member (the pivot shaft) to produce a friction resistance and to hold the second hinge member positively in position relative to the first hinge member after each rotary motion by an external biasing force.

2. Description of the Related Art

A consumer electronic product with a lifting cover such as mobile computer, electronic dictionary, mobile video player, cell phone, etc., commonly uses a hinge to coupled the cover to the base member so that the cover can be opened from or closed on the base member. Therefore, the hinge also determines the quality level of the product.

A good hinge allows positive positioning and does not cause noises during operation. There is known a sleeve joint type hinge, which comprises a female hinge member, which defines therein an axle hole, a male hinge member, which has a split shaft body positioned in the axle hole. The split shaft body of the male hinge member has two friction portions disposed in friction engagement with the peripheral wall of the axle hole of the female hinge member. However, this design of sleeve joint type hinge is not durable in use because the friction portions wear quickly with use.

### SUMMARY OF THE INVENTION

The present invention has been accomplished under the circumstances in view. According to one aspect of the present invention, the sleeve joint type hinge comprises a barrel, a pivot shaft, and at least one resilient friction member. The barrel has a first end, a second end opposite to the second end, and a receiving open chamber axially extending from the first end toward said second end and surrounded by an inside wall of the barrel. The pivot shaft is inserted into the receiving open chamber of the barrel and rotatable relative to the barrel, having a shaft body, two longitudinal locating grooves on the periphery of the shaft body at two opposite sides, and a mounting portion for mounting axially extending from one end of the shaft body for mounting. The at least one resilient friction member is respectively mounted on the shaft body of the pivot shaft within the receiving open chamber and disposed in contact with the inside wall of the barrel and rotatable with the pivot shaft relative to the barrel to produce a friction resistance. The at least one resilient friction member each has a protruding portion disposed in contact with the inside wall of the barrel, and two hooked portions respectively extending from two distal ends thereof and respectively hooked in the longitudinal locating grooves of the pivot shaft.

According to another aspect of the present invention, the mounting portion of the pivot shaft and the mounting portion of the barrel each have at least one mounting hole for mounting. Further, the mounting portion of the pivot shaft and the mounting portion of the barrel can be made having at least one longitudinally extending plane.

According to still another aspect of the present invention, the shaft body of the pivot shaft has at least one longitudinal tangential plane corresponding to the protruding portion of each o resilient friction member, and the protruding portion of each resilient friction member is kept spaced from one longitudinal tangential plane of the pivot shaft.

According to still another aspect of the present invention, the at least one resilient friction member each has a plurality of lubricating grease retaining holes.

According to still another aspect of the present invention, the number of the at least one resilient friction member is 2, and the two resilient friction members are abutted against each other to form a friction ring that is sleeved onto the shaft body of the pivot shaft.

### BRIEF DESCRIPTION OF THE DRAWINGS

FIG. 1 is an exploded view of a sleeve joint type hinge according to a first embodiment of the present invention.

FIG. 2 corresponds to FIG. 1 when viewed from another angle.

FIG. 3a is a cross sectional view of the sleeve joint type hinge according to the first embodiment of the present invention.

FIG. 3b is a longitudinal sectional view of the sleeve joint type hinge according to the first embodiment of the present invention.

FIG. 4 is an exploded view of an alternate form of the sleeve joint type hinge according to a second embodiment of the present invention.

FIG. 5 corresponds to FIG. 4 when viewed from another angle.

FIG. 6a is a cross sectional view of the sleeve joint type hinge according to the second embodiment of the present invention.

FIG. 6b is a longitudinal sectional view of the sleeve joint type hinge according to the second embodiment of the present invention.

### DETAILED DESCRIPTION OF THE PREFERRED EMBODIMENT

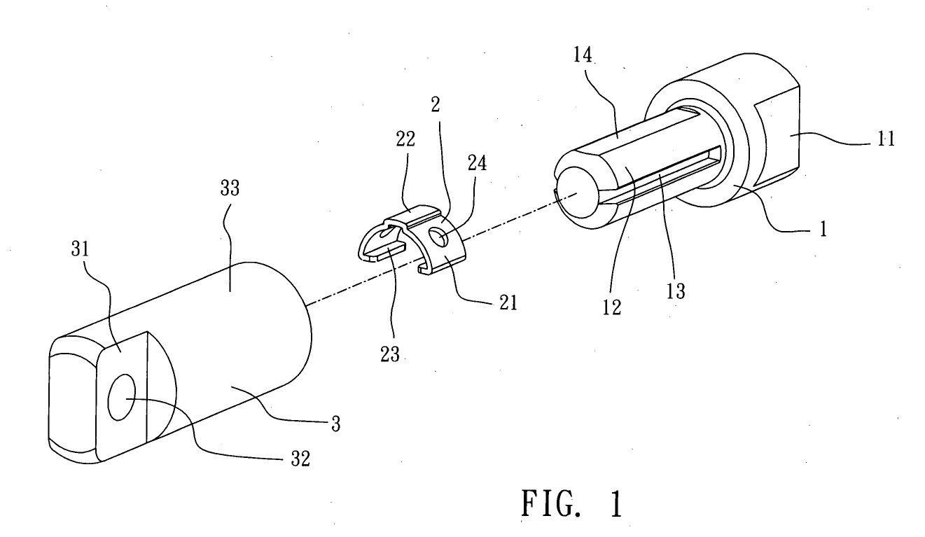

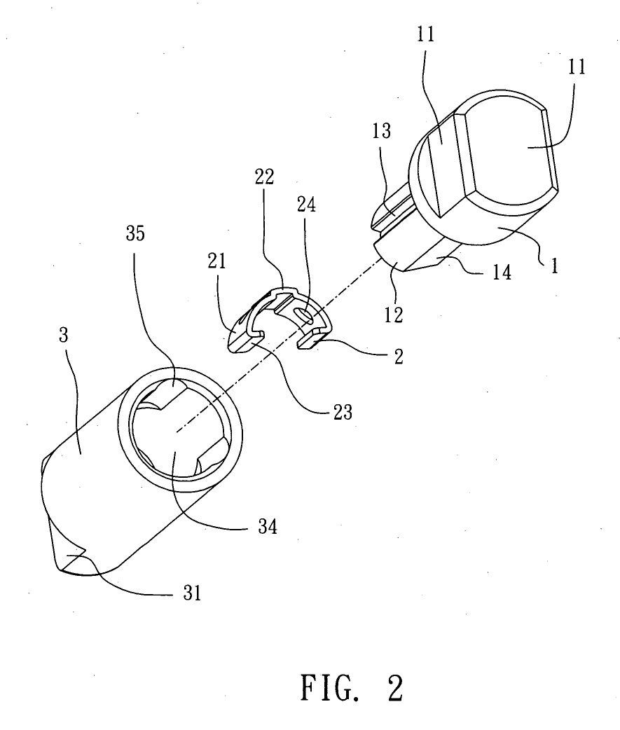

Referring to FIGS. 1˜3, a sleeve joint type hinge in accordance with a first embodiment of the present invention is shown comprised of a pivot shaft 1, a friction member 2, and a barrel 3.

The pivot shaft 1 has a mounting portion 11 disposed at one side for fastening to a body, for example, the cover member of a mobile electronic device, and a shaft body 12 disposed at the other side for coupling to the barrel 3. The mounting portion 11 can be a triangular, rectangular, or polygonal prism. Further, the mounting portion 11 can be made having at least one, for example, a number of mounting through holes for fastening to the cover member of a mobile electronic device with fastening members, for example, screws. The shaft body 12 has two longitudinal locating grooves 13 on the periphery at two opposite sides, and at least one, for example, two tangential planes 14 longitudinally formed on the periphery and respectively equally spaced from the longitudinal locating grooves 13 at two opposite sides.

The friction member 2 is smoothly arched metal spring plate, having two arched body portions 21 symmetrically disposed at two opposite lateral sides and respectively extending outwardly downwards, a protruding middle portion 22 connected between the arched body portions 21, which is kept in alignment with spaced from one tangential plane 14 of the pivot shaft 1, two hooked portions 23 respectively extending from the a arched body portions 21 opposite to the protruding middle portion 22, and a plurality of grease retaining holes 24 respectively formed on the arched body portions 21 for accumulation of a lubricating grease and supply of the accumulated lubricating grease upon rotation of the friction member 2 with the shaft member 1 relative to the barrel 3.

The barrel 3 has a barrel body 33, a receiving open chamber 34 defined in the barrel body 33 and axially extending to one end of the barrel body 33 in communication with the atmosphere, at least one positioning groove, for example, two positioning grooves 35 formed on the inside wall of the barrel body 33 within the receiving open chamber 34 for selectively receiving the protruding middle portion 22 of the friction member 2 to hold the shaft member 1 firmly to the barrel 2 in the zero-angle (close) position or maximum-angle (fully opened) position, and a mounting portion 31 extended from the other end of the barrel body 33 for fastening to, for example, the base member of the aforesaid mobile electronic device. The mounting portion 31 of the barrel 3 can be made in the shape of a flat bar, triangular prism, rectangular bar, or polygonal bar. Further, the mounting portion 31 can be made having a mounting through hole 32 for fastening to the base member of the mobile electronic device with a fastening member, for example, screw.

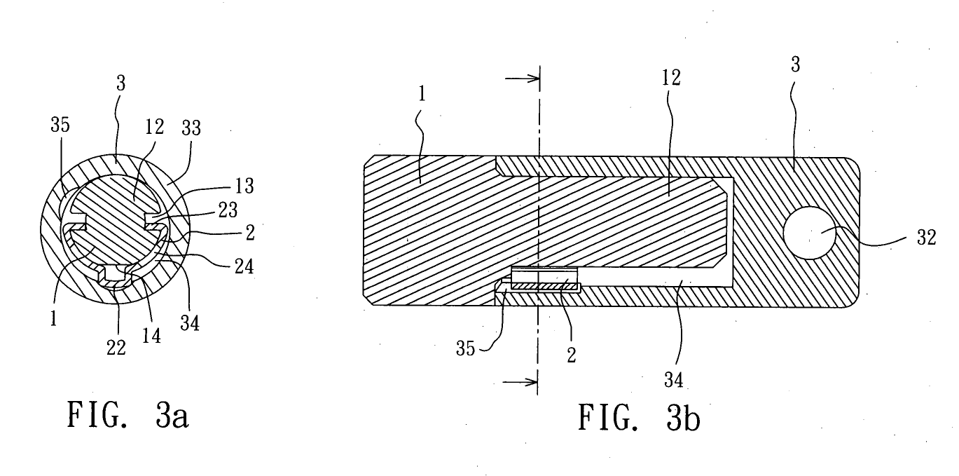

FIGS. 3a and 3b show the pivot shaft 1, the friction member 2 and the barrel 3 assembled. When turning the pivot shaft 1 relative to the barrel 3 with a biasing force, the protruding middle portion 22 of the friction member 2 is forced against the inside wall of the barrel 3, producing a friction resistance between the pivot shaft 1 and the barrel 3 positively, therefore the pivot shaft 1 is positively kept in position when the biasing force is disappeared.

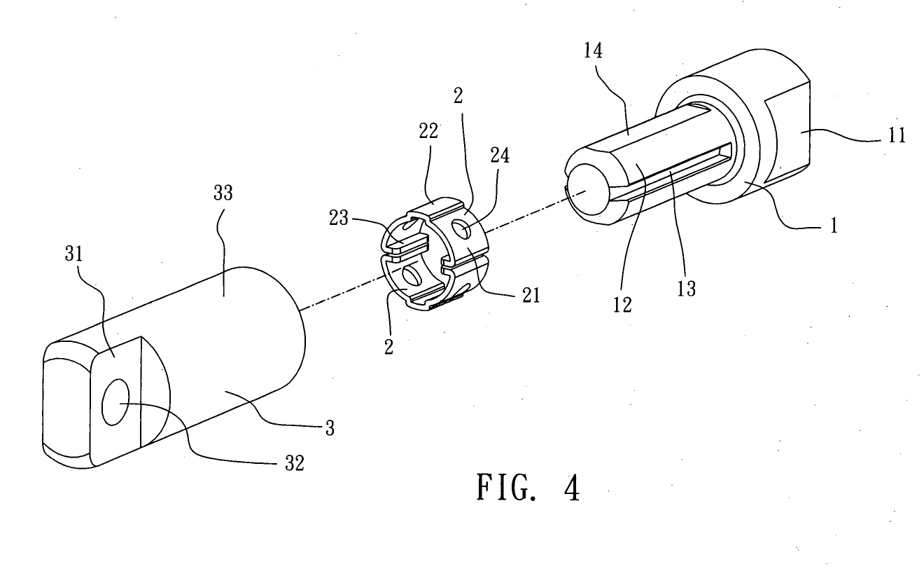

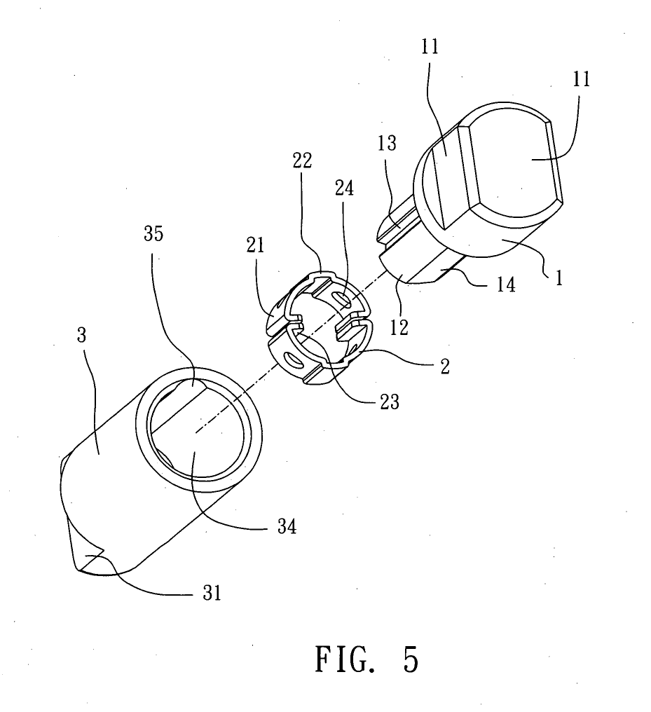

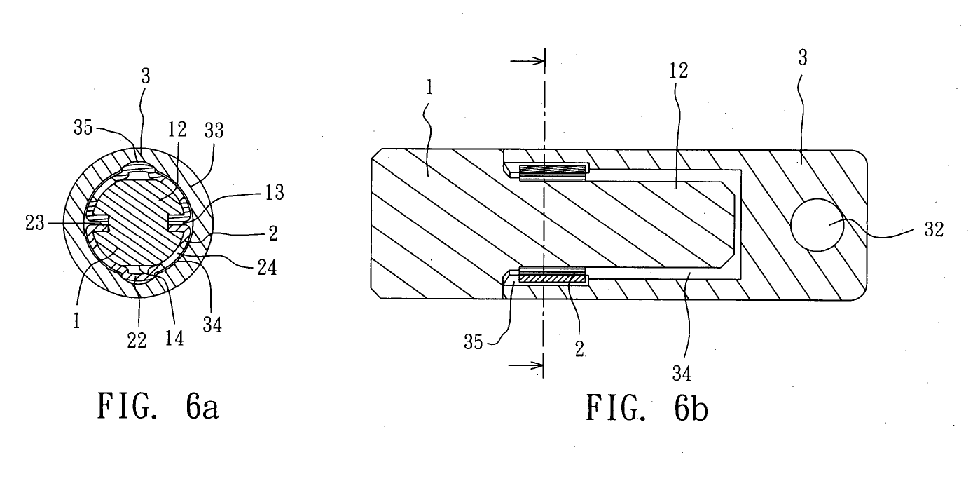

FIGS. 4˜6 show a sleeve joint type hinge in accordance with a second embodiment of the present invention. This embodiment is substantially similar to the aforesaid first embodiment with the exception that two friction members 2 are used. According to this second embodiment, the hooked portions 23 of one of the friction members 2 are respectively and fixedly fastened to the hooked portions 23 of the other friction member, holding the two friction members 2 in the shape of a ring. Thereafter, the friction ring formed of the two friction members 2 is sleeved onto the shaft body 12 of the pivot shaft 1 to force the hooked portions 23 into the locating grooves 13. This embodiment provides an enhanced friction resistance between the pivot shaft 1 and the barrel 3.

As indicated above, the present invention provides a sleeve joint type hinge, which comprises a barrel, a pivot shaft inserted into the barrel and rotatable relative to the barrel, and a friction member (or friction members) arranged between the barrel and the pivot shaft and turnable with the pivot shaft relative to the barrel to produce a friction resistance and to hold the pivot shaft positively in positive after disappearance of the external biasing force.

Although particular embodiments of the invention have been described in detail for purposes of illustration, various modifications and enhancements may be made without departing from the spirit and scope of the invention.

What is claimed is:

1. A sleeve joint type hinge comprising:
a barrel, said barrel having a first end, a second end opposite to said second end, and a receiving open chamber axially extending from said first end toward said second end and surrounded by an inside wall thereof;
a pivot shaft inserted into the receiving open chamber of said barrel and rotatable relative to said barrel, said pivot shaft having a shaft body, two longitudinal locating grooves on the periphery of said shaft body at two opposite sides, and a mounting portion for mounting axially extending from one end of said shaft body for mounting; and
at least one resilient friction member mounted on said shaft body of said pivot shaft within said receiving open chamber and disposed in contact with the inside wall of said barrel and rotatable with said pivot shaft relative to said barrel to produce a friction resistance, said at least one resilient friction member each having a protruding portion disposed in contact with the inside wall of said barrel and two hooked portions respectively extending from two distal ends thereof and respectively hooked in the longitudinal locating grooves of said pivot shaft.

2. The sleeve joint type hinge as claimed in claim 1, wherein the mounting portion of said pivot shaft and the mounting portion of said barrel each have at least one mounting hole for mounting.

3. The sleeve joint type hinge as claimed in claim 1, wherein the mounting portion of said pivot shaft and the mounting portion of said barrel each have at least one longitudinally extending plane.

4. The sleeve joint type hinge as claimed in claim 1, wherein the shaft body of said pivot shaft has at least one longitudinal tangential plane corresponding to the protruding portion of each of said at least one resilient friction member, and the protruding portion of each of said at least one resilient friction member is respectively kept spaced from said at least one longitudinal tangential plane.

5. The sleeve joint type hinge as claimed in claim 1, wherein said at least one resilient friction member each is smoothly arched.

6. The sleeve joint type hinge as claimed in claim 1, wherein said at least one resilient friction member each has a plurality of lubricating grease retaining holes.

7. The sleeve joint type hinge as claimed in claim 1, wherein said at least one resilient friction member each is smoothly arched; the number of said at least one resilient friction member is 2, and the two resilient friction members are abutted against each other to form a friction ring that is sleeved onto said shaft body of said pivot shaft.
